(19) United States
(12) Patent Application Publication
(10) Pub. No.: US 2006/0100926 A1
(43) Pub. Date: May 11, 2006

(54) On demand advertising

(75) Inventors: Scott Sina Abedi, Durham, NC (US); Thomas Joseph Prorock, Raleigh, NC (US); James Stephen Rutledge, Durham, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/986,483

(22) Filed: Nov. 11, 2004

(51) Int. Cl. G06Q 30/00

(52) U.S. Cl. 705/14

(57) ABSTRACT

A method and system for transmitting marketing messages, such as advertisements and/or coupons, to shoppers in a store. The marketing messages are transmitted by a low-power line-of-sight transmitter which is positioned in a specific predetermined product area. After determining the identity of a passing shopper, a tailored marketing message is sent to a wireless device being used by the passing shopper. A determination is made as to how long the marketing message was displayed on the wireless device and whether the shopper responded to the marketing message by purchasing a product that is targeted by the marketing message. Since the line-of-sight transmitter is low-power, there is no reflective bleed-over of a carrier signal for the marketing message. Since the marketing message is specifically limited to passing shoppers within a tightly defined area, the assessment of a fee charged to an advertiser for transmitting the marketing message is more exact.

### BACKGROUND OF THE INVENTION

1. Technical Field

The present invention relates in general to the field of computers, and in particular to wireless computers receiving signals from short-range transmitting devices. Still more particularly, the present invention relates to a method and system for selectively broadcasting marketing messages, such as advertisements and coupons, to a wireless computer mounted on a shopping cart in a store.

2. Description of the Related Art

A key feature desired in advertisement is targeting a market. That is, there is little, if any, short term benefit to the advertiser from sending advertisements to persons who are not likely to purchase the advertiser's product. This is especially true at the actual time of the purchase, such as in a grocery store or similar retail establishment. To target the buying audience in such an environment, the prior art uses two main types of advertising. The first is the broadcasting of an ad playlist throughout the store. Such a playlist may be as simple as an audio message over the store's public address system, or may be via high-tech devices such as wireless Personal Digital Assistants (PDAs). Alternatively, ads can be broadcast to PDAs in only in a limited area by using short-range Bluetooth® technology. An example of such ad placement methods is described in U.S. patent application Ser. No. 09/859,359, entitled “Method and System for Providing Targeted Advertising and Personalized Customer Services,” filed by Hind et al. on May 17, 2001, and herein incorporated by reference in its entirety.

While the prior art provides a certain level of targeted advertising, what is needed is additional refinement to effectively gauge the effectiveness of the advertisements, and to charge the advertiser accordingly. Further, there is a need to tailor the advertisement to products that the user needs or is likely to need, based on the user's shopping history (both short term as well as long term). Preferably, such a method and system will require minimal user intervention.

### SUMMARY OF THE INVENTION

The present invention is thus directed to a method and system for transmitting marketing messages, such as advertisements and/or coupons, to shoppers in a store. The marketing messages are transmitted by a low-power line-of-sight transmitter which is positioned in a specific predetermined product area. After determining the identity of a passing shopper, the transmitter sends a tailored marketing message to a wireless device being used by the passing shopper. A determination is made as to how long the marketing message was displayed on the wireless device before being turned off, if ever, and whether the shopper responded to the marketing message by purchasing a product that is targeted by the marketing message. Since the line-of-sight transmitter is low-power, there is no reflective bleed-over of a carrier signal for the marketing message. Since the marketing message is specifically limited to passing shoppers within a tightly defined area, the assessment of a fee charged to an advertiser for transmitting the marketing message is more exact.

The marketing message is thus transmitted in real-time to the wireless device via a line-of-sight carrier signal, which is preferably an infrared (IR) signal.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1 illustrates an exemplary computer system in which the present invention can be implemented, either as a wireless device for receiving a marketing message, a transmitter/receiver for communicating with the wireless device, and/or as a server that exchanges data with the wireless device via the transmitter/receiver;

FIG. 2 depicts an exemplary environment in which the wireless device is mounted to a shopping cart in a store;

FIG. 3 is an exemplary store plan layout in which the present invention may be implemented;

FIG. 4 illustrates a look-up table that correlates items that have been previously selected by a shopper with other associated products;

FIG. 5 depicts an exemplary Graphical User Interface (GUI) on the wireless device offering one of the associated products to the shopper;

FIG. 6 is a flow chart of steps taken in a preferred embodiment of the present invention to transmit the marketing messages; and

FIG. 7 is a flow chart of steps taken in a preferred embodiment of the present invention to determine how much to charge an advertiser for marketing messages that are transmitted on the advertiser's behalf.

### DETAILED DESCRIPTION OF THE PREFERRED EMBODIMENT

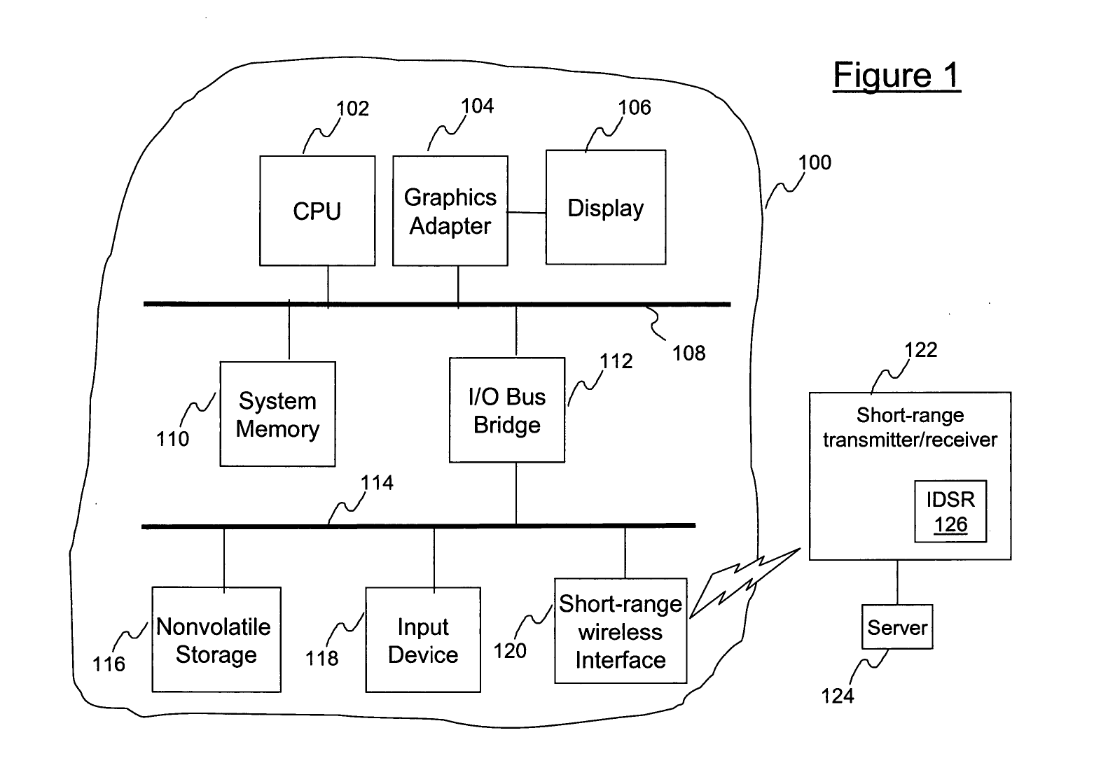

With reference now to FIG. 1, there is depicted a block diagram of an exemplary data processing system in which a preferred embodiment of the present invention may be implemented. Data processing system 100 includes a central processing unit (CPU) 102, which is connected to a system bus 108. In the exemplary embodiment, data processing system 100 includes a graphics adapter 104 also connected to system bus 108, for providing user interface information to a display 106.

Also connected to system bus 108 are a system memory 110 and an input/output (I/O) bus bridge 112. I/O bus bridge 112 couples an I/O bus 114 to system bus 108, relaying and/or transforming data transactions from one bus to the other. Peripheral devices such as nonvolatile storage 116, which may be a hard disk drive, and input device 118, which may include a conventional mouse, a trackball, or the like, as well as a bar code or similar reader, is connected to I/O bus 114.

Data processing system 100 also includes a wireless interface 120. Wireless interface 120 is an interface that permits data processing system 100 to wirelessly communicate, preferably via a line-of-sight carrier signal such as a low-power infrared (IR) wave, with another data processing system, such as a short-range transmitter/receiver system 122, which also communicates with a server 124. Note that in a preferred embodiment, all communication is tuned down to a low-power level IR, such that there is only line-of-sight communication, such that no wireless communication occurs from reflected or other “bleed over” signals.

Short-range transmitter/receiver 122 may also include an IDentification Signal Receiver (IDSR) 126. IDSR 126 is a logic (hardware and/or software) that receives and processes an identification signal from a wireless computer such as a Personal Shopping Device (PSD).

In a preferred embodiment, the features shown for data processing system 100 are used by the PSD, while the short-range transmitter/receiver 122 uses all features shown for data processing system 100 except for the graphics adapter 104 and display 106, and the server 124 has all features shown for data processing system 100 except for the short-range wireless interface, since server 124 and short-range transmitter/receiver 122 preferably are able to communicate across long distances.

The exemplary embodiment shown in FIG. 1 is provided solely for the purposes of explaining the invention. Those skilled in the art will recognize that numerous variations are possible, both in form and function. For instance, data processing system 100 might also include a compact disk read-only memory (CD-ROM) or digital versatile disk (DVD) drive, a sound card and audio speakers, and numerous other optional components. All such variations are believed to be within the spirit and scope of the present invention.

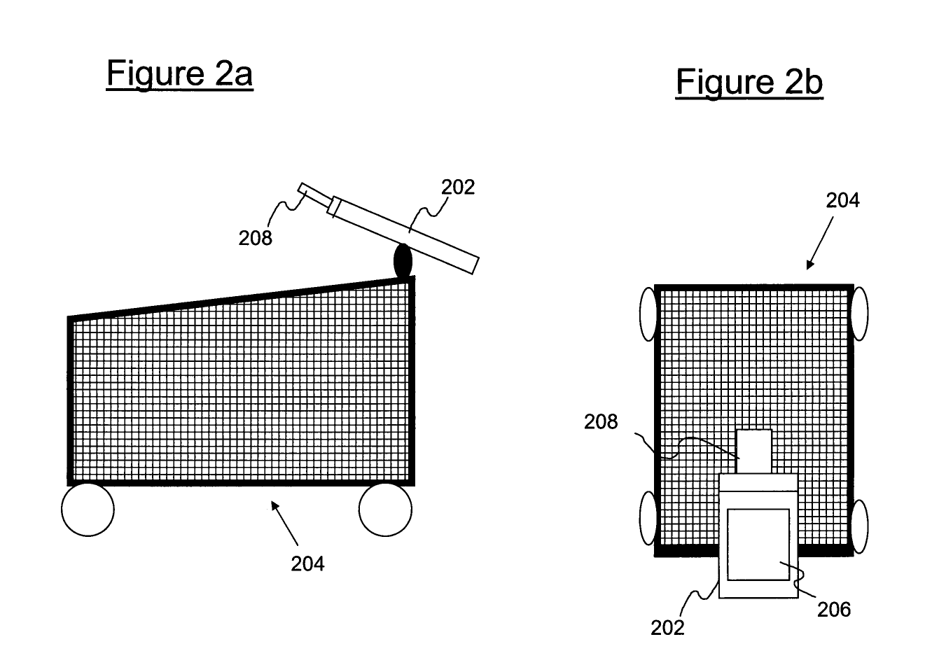

Referring now to FIGS. 2a-b, an exemplary use of data processing system 100 is shown. Data processing system 100 is depicted as a Personal Shopping Device (PSD) 202, which is attached to a shopping cart 204, preferably in a manner that is semi-fixed (i.e., requiring tools to remove PSD 202 from shopping cart 204, in order to prevent the theft of PSD 202). As seen in the top view of FIG. 2b, PSD 202 has an active viewing screen 206, which displays a Graphical User Interface (GUI) for displaying data, as well as for receiving inputs (preferably via a touch-screen capability) into PSD 202.

An exemplary use of PSD 202 may be in a retail establishment. As a shopper places items into shopping cart 204, the shopper scans the product using a bar code reader 208, which reads a Universal Product Code (UPC) bar code from a product selected by the shopper and records the product in PSD 202. The PSD 202 stores all items that have been scanned and placed in the shopping cart 204 into a list. When the customer checks out, the checker simply downloads the list (with prices) to conclude a shopping transaction.

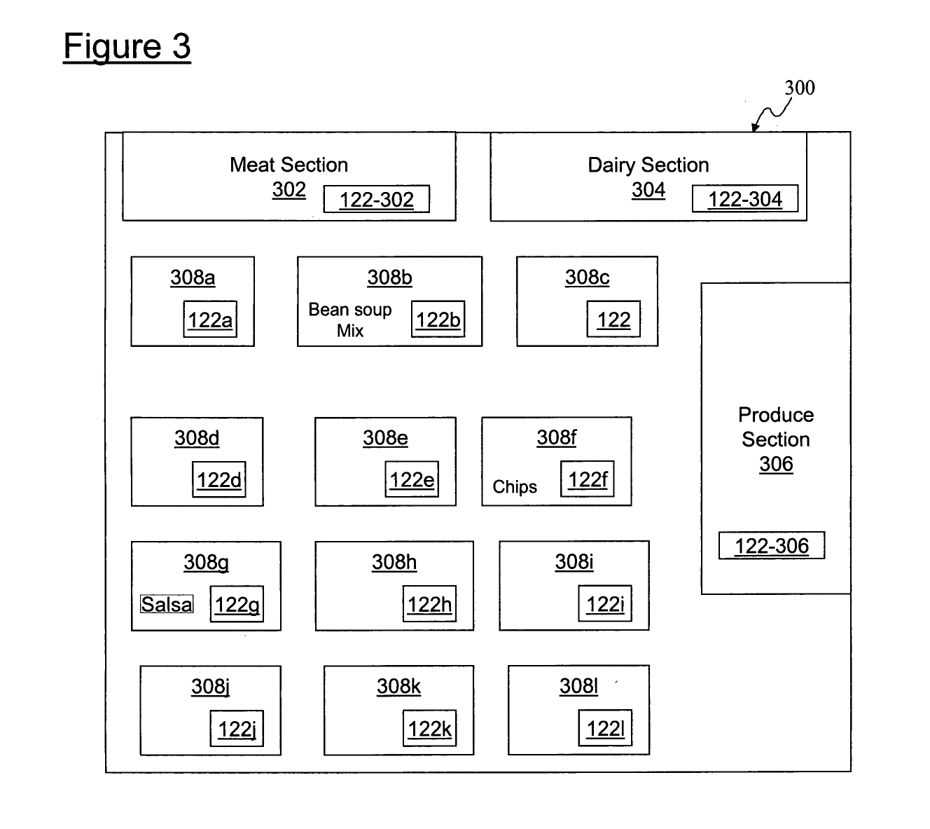

Referring now to FIG. 3, there is illustrated an exemplary environment in which the present invention may be utilized. Store plan 300 depicts an arrangement of a retail store having multiple pre-determined product areas 308. Within each product area 308 is a short-range transmitter/receiver 122. Each short-range transmitter/receiver 122 preferably uses a low-power infrared (IR) carrier signal, such that communication with a short-range transmitter/receiver 122 is only available within the associated pre-determined product area 308 via line-of-sight, and not via reflected or other bleed-over signals. For exemplary purposes, note that store plan 300 may include a meat section 302, a dairy section 304, and a produce section 306, each section also being a pre-determined product area having a short-range transmitter/receiver 122.

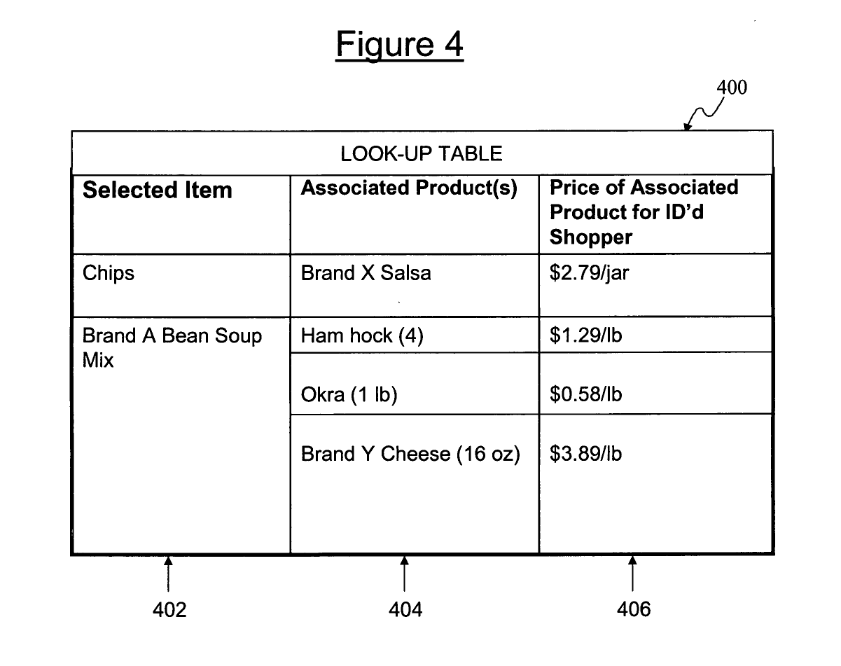

Referring now to FIG. 4, there is depicted a look-up table 400. Look-up table 400 includes a listing of selected products 402, associated products 404, and prices 406. As will be discussed below, there is some type of logical association between the each of the selected products 402 (which a shopper has previously selected and placed in his shopping cart) and each of the associated products 404. Furthermore, each of the prices 406 that are associated with one of the associated products 404 can be dynamically changed, as discussed in detail below.

In a preferred embodiment, associated products 404 are defined and related to a corresponding selected product 402 by an advertiser. For example, consider the situation in which a shopper has placed a bag of chips (shown as a selected product 402) in his basket while in pre-determined product area 308f. When that same shopper reaches pre-determined product area 308g, a marketing message is sent to that user's PSD 202 suggesting that he pick up the advertiser's “Brand X” salsa listed as one of the associated products 404. That is, preferably the selected product 402 is any brand of that described product, while the associated product 404 is that sold by the advertiser (manufacturer) who is paying for the transmission of the marketing message.

In another preferred embodiment, associated products 404 are defined by a recipe, such as listed on a package. For example, consider the scenario in which the shopper selects a specific bean soup mix, as shown as one of the selected products 402. Printed on the packaging for the bean soup mix, and known to server 124, is a listing of all ingredients that need to be added to the mix, including ingredients that may not be usually kept on hand at the shopper's home. Thus, when the shopper scans and places the bean soup mix in his shopping cart, server 124, upon a local IDSR 126 in a short-range transmitter/receiver 122 subsequently detecting that the shopper who chose the bean soup mix is in a particular pre-determined area, will send marketing messages for the needed ingredients. For example, consider when a shopper selects, scans, and places the particular bean soup mix in his basket when in pre-determined product area 308b. Then, while passing through another pre-determined product area, such as meat section 302, a suggestion (marketing message) message is sent to that user reminding him to pick up ham hocks for his soup. Optionally, a special price for that shopper alone, may be offered. Thus, the prices 406 can be dynamically modified. Similarly, suggestions are made to the shopper when in dairy section 304 to pick up needed Brand Y cheese and to pick up okra from when in the produce section 306.

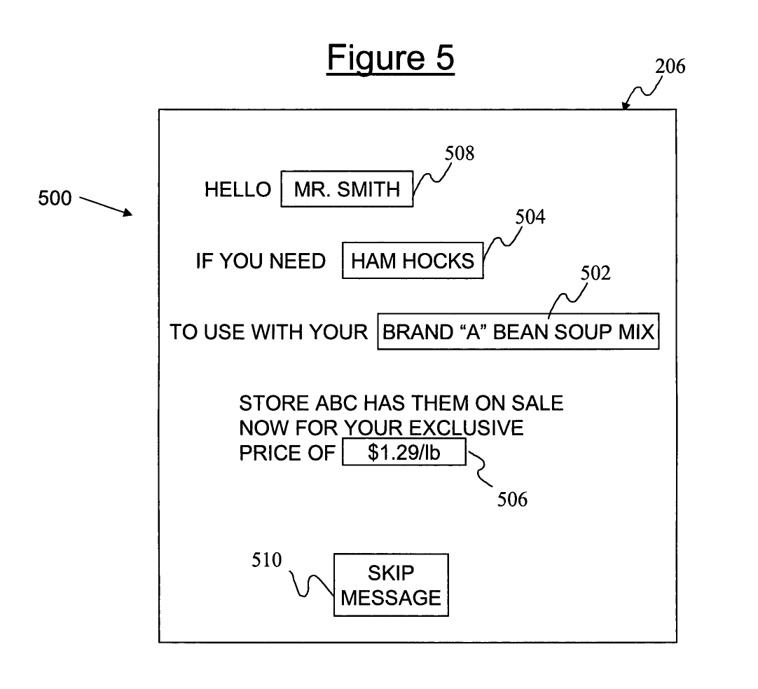

Referring now to FIG. 5, a GUI 500, displayed on active viewing screen 206 of PSD 202, is shown as it would appear when the shopper who selected the bean soup mix passes through the meat section 302. The GUI 500 includes dynamically populated active region 502, which is populated from a selected product 402 in look-up table 400. Similarly, active region 504 is populated from associated products 404, while active field 506 is populated from prices 406. Active field 508 is populated by the ISDR 126 in a local short-range transmitter/receiver 122, which, using the shopper's ID, sends the shopper's actual name to active field 508. If the shopper wishes to skip the marketing message at any time, then he clicks (touches the active screen) the skip button 510. If and when the skip button 510 is clicked, the local short-range transmitter/receiver 122 and the server 124 record this event, and how long the marketing message was displayed in the GUI 500.

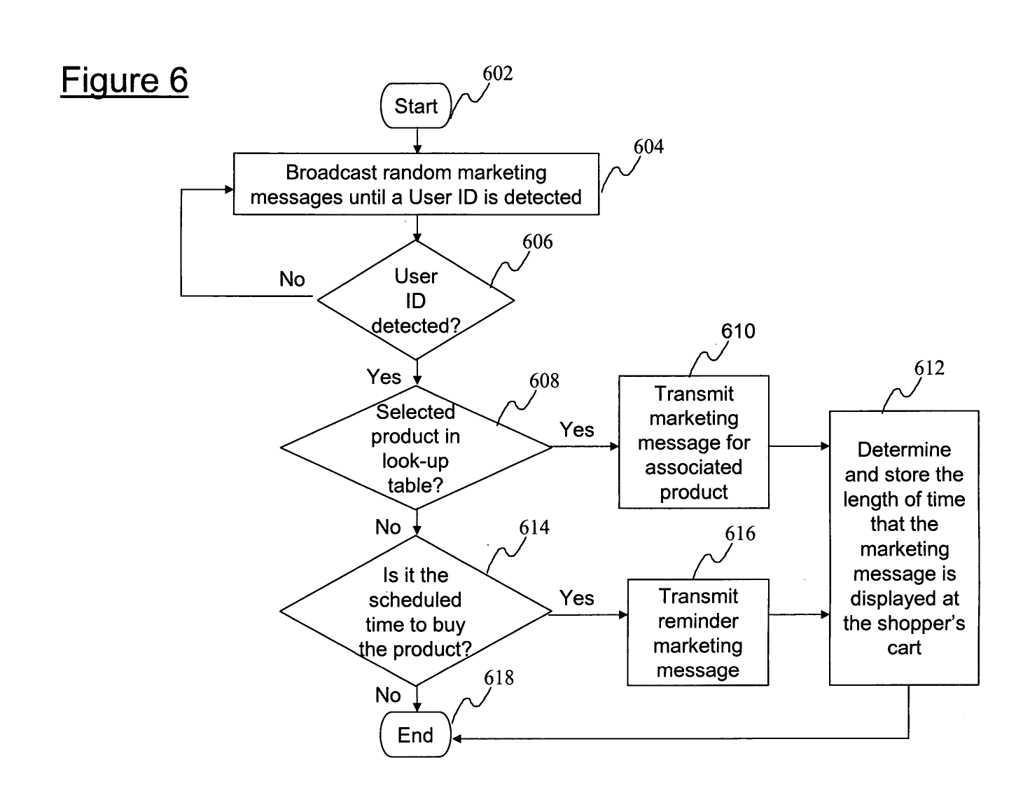

With reference now to FIG. 6, a flow chart of preferred steps taken to display a marketing message is shown. After initistor block 602, a random marketing message is broadcast (block 604) within a short-range predetermined area, such as by one of the short-range transmitters/receivers 122 shown in FIG. 3. These random marketing messages are broadcast to any PSD 202 until an identifier (ID) from a PSD 202 is detected by the IDSR 126 in the short-range transmitter/detector 122 (query block 606). Preferably, these marketing messages are stored in either the server 124, or alternatively the short-range transmitter/receiver 122, which broadcasts the marketing message in real time to the PSD 202, preferably via a low-power infrared (IR) carrier signal that is only line-of-sight enabled (not capable of being read after reflection, deflection, etc.), thus ensuring that the IR signal is only read within the short-range predetermined area.

Next, a query is made (query block 608) as to whether a product, which has been physically selected and placed in her shopping cart, matches one of the selected products 402 in look-up table 400. If so, then a marketing message related to one of the associated products 404 is broadcast to the PSD 202 (block 610). The length of time that the marketing message was displayed on the GUI in the PSD 202 is determined and stored by the short-range transmitter/receiver 122 and/or the server 124 (block 612).

A query is also made (query block 614) as to whether it is the scheduled time for the user identified to purchase an item located with the pre-determined product area in which the short-range transmitter/receiver 122 is located. A shopping history, stored in short-range transmitter/receiver 122 and/or server 124, for the shopper identified by the ID from the PSD 202, is accessed. This shopping history includes a periodic schedule of when specific items should be purchased by the shopper. For example, the shopping history may know that the shopper needs to buy a new air conditioner filter every 60 days. If 60 days have elapsed since the shopper purchased her last air conditioner filter, then a reminder message is sent to the PSD 202 (block 616), preferably suggesting that the shopper purchase a particular brand and/or model of air conditioner filter. The length of time that this reminder message is likewise stored (block 612), and the process ends (terminator block 618).

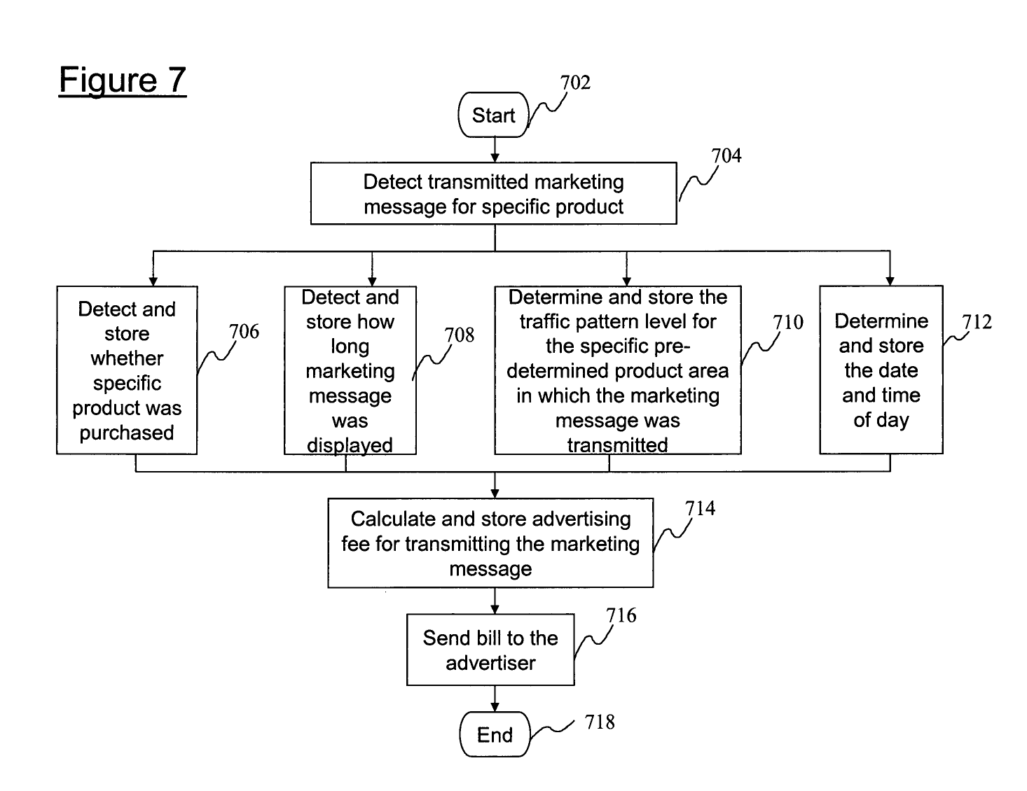

With reference now to FIG. 7, a flow chart is shown of preferred steps taken to calculate a bill for the company on whose behalf the marketing message was sent. After initiator block 702, the transmission of a particular marketing message (advertisement, coupon, reminder, etc.) for a particular product is detected (block 704) by a PSD 202 and/or a server 124. After the particular marketing message is sent, a determination is made as to whether the product that is the subject of the marketing message was purchased by the shopper who received the marketing message (block 706). This determination is made by monitoring the check-out process performed by the shopper at the end of his shopping trip. The advertising manufacturer or distributor of the product promoted in the marketing message is then billed accordingly (block 714), with the advertising manufacturer paying more if her product was selected than if not.

Similarly, by monitoring how long the shopper was within range of the short-range transmitter/receiver, whether another overriding marketing message was sent to that shopper while in the same pre-determined product area, or whether or not the shopper manually ended the marketing message display by clicking a “Skip” button on the GUI, a determination is made as to how long the marketing message was displayed (block 708). The charge to the advertiser (producer) of the addressed product is then charged according to how long his advertisement was displayed.

Similarly, the charge for transmitting the marketing message may depend on how heavy store traffic is in the area in which the marketing message was displayed (block 710). This is particularly germane if the marketing message is being transmitted to any PSD 202 within range, regardless of the user ID, if any, of the shopper. Obviously, if the marketing message is being broadcast in a higher traffic area, then the fee to the advertiser is likewise higher as well.

Similarly, the date and time during which a marketing message made on behalf of an advertiser is determined and stored (block 712). Again, this is more germane if the marketing message is transmitted to any PSD 202 within range. If the marketing message is being transmitted during peak shopping times, such as between 5:00 P.M. and 7:00 P.M., then the charge to the advertiser will be higher than for marketing messages that are transmitted to off-peak hours, such as between 10:00 P.M. and midnight.

After the fee for the transmitted marketing message has been determined and stored (block 716), then a bill is generated for each advertiser who used the marketing message transmission service as described herein, and the process ends (terminator block 718).

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention thus provides a simple method and system for not only generating dynamic local advertisement to shoppers, but also for determining the actual or likely effectiveness of the advertisement, and generating an equitable bill based on this determined effectiveness level.

While the invention has been particularly shown and described with reference to a preferred embodiment, it will be understood by those skilled in the art that various changes in form and detail may be made therein without departing from the spirit and scope of the invention.

What is claimed is:

1. A method comprising:
positioning a short-range transmitter in a predetermined product area in a store;
storing one or more marketing messages in the short-range transmitter, wherein the one or more marketing messages are associated with one or more specific products located in the predetermined product area;
transmitting the one or more marketing messages to a wireless computer; and
gauging the effectiveness of the transmitted marketing messages.

2. The method of claim 1, further comprising:
sending a user identifier for a user from the wireless computer to a receiver associated with the short-range transmitter, wherein the receiver is in communication with a user database.

3. The method of claim 2, wherein the one or more marketing messages are tailored to a user identified by the user identifier.

4. The method of claim 3, wherein the user identifier associates the user with a record of which items the use has physically selected in the store.

5. The method of claim 4, wherein the database associates one or more associated items with one of the items that have been physically selected by the user.

6. The method of claim 5, wherein at least one of the associated items are in the predetermined product area, and wherein a marketing message for one or more of the associated items is transmitted to the wireless device.

7. The method of claim 6, wherein the associated items are from a recipe list printed on the physically selected item.

8. The method of claim 2, wherein the marketing message is determined by a pre-determined purchasing schedule for a product in the pre-determined product area, and wherein the purchasing schedule is specific for a specific user.

9. The method of claim 2, wherein the marketing message is determined by a history of when the user last viewed the marketing message.

10. The method of claim 1, further comprising:
coupling a receiver to the short-range transmitter, wherein the receiver and the short-range transmitter are capable of providing communication between the wireless computer and a server.

11. The method of claim 10, wherein the transmitter and receiver detect a length of time that a marketing message is displayed on the wireless computer.

12. The method of claim 11, wherein a charge for transmitting the marketing message from the transmitter to the wireless computer is based on the length of time that the marketing message is displayed on the wireless computer.

13. The method of claim 10, wherein a charge for transmitting the marketing message from the transmitter to the wireless computer is based on a percentage of occurrences in which a customer purchases a particular product after viewing the marketing message, thus gauging the immediate effectiveness of the marketing message.

14. The method of claim 1, wherein a charge for transmitting the marketing message is based on a location in the store in which the transmitter is located.

15. The method of claim 14, wherein a higher fee is charged for marketing messages transmitted in an area of the store that has higher customer traffic.

16. The method of claim 1, wherein the marketing message is an advertisement for a specific product in the pre-determined product area, and wherein the advertisement is displayed on a display of the wireless computer.

17. The method of claim 2, wherein the marketing message is a coupon for a specific product in the pre-determined product area, and wherein the coupon is available only to the user identified by the user identifier.

18. The method of claim 1, wherein the short-range transmitter transmits the marketing message to the wireless computer via an infrared (IR) carrier signal whose range is strictly limited to the predetermined product area.

19. A system comprising:
a short-range transmitter positioned in a predetermined product area in a store;
a wireless computer mounted on a shopping cart; and
storage means in the short-range transmitter for storing one or more marketing messages, wherein the one or more marketing messages are associated with one or more specific products located in the predetermined product area, and wherein one or more of the marketing messages are transmitting from the short-range transmitter to the wireless computer.

20. A computer program product, residing on a computer usable medium, comprising:
program code for positioning a short-range transmitter in a predetermined product area in a store;
program code for storing one or more marketing messages in the short-range transmitter, wherein the one or more marketing messages are associated with one or more specific products located in the predetermined product area; and
program code for transmitting the one or more marketing messages to a wireless computer.
